(19) United States
(12) Patent Application Publication
(10) Pub. No.: US 2025/0267767 A1
(43) Pub. Date: Aug. 21, 2025

(54) Method for a Load-Dependent Setting of a Microwave Power in a Cooking Appliance

(71) Applicant: RATIONAL Aktiengesellschaft, Landsberg am Lech (DE)

(72) Inventors: Felix KIELMANN, Landsberg am Lech (DE); Christian KOENEN, Landsberg am Lech (DE)

(21) Appl. No.: 19/059,965

(22) Filed: Feb. 21, 2025

(30) Foreign Application Priority Data
Feb. 21, 2024 (DE) 10 2024 104 882.4

(51) Int. Cl. H05B 1/02; H05B 6/64

(52) U.S. Cl. CPC H05B 1/0261; H05B 6/6447

(57) ABSTRACT

The present disclosure relates to a method for a load-dependent setting of a microwave power in a cooking appliance having a cooking chamber and a microwave module. The method includes determining a number of dielectric unit volumes in the cooking chamber. A target microwave power is determined on the basis of the number of dielectric unit volumes. The microwave power of the microwave module is set on the basis of the determined target microwave power. Furthermore, a cooking appliance is provided with functionality to execute the method.

### CROSS-REFERENCE TO RELATED APPLICATIONS AND PRIORITY

This patent application claims priority from German Patent Application No. 10 2024 104 882.4 filed Feb. 21, 2024. This patent application is herein incorporated by reference in its entirety.

### FIELD OF THE DISCLOSURE

Embodiments of the present disclosure relate to a method for a load-dependent setting of a microwave power in a cooking appliance. Furthermore, embodiments of the present disclosure relate to a cooking appliance.

### BACKGROUND

Many conventional cooking appliances, which heat cooking products mainly with hot air or comparable heating devices, provide reproducible cooking results, particularly independently of the load quantity, which is however due to the fact that users have an intuitive understanding of how a cooking method carried out by means of hot air must be adapted to a changed load quantity and/or how a cooking process must be extended if a target cooking chamber climate or a target heating power cannot be achieved, provided that an intelligent cooking method is used. In simple terms, a user gets at least approximately the same cooking results for different cooking processes, regardless of whether, for example, he places half a tray of steaks (=3 steaks) or 3 trays of steaks (=18 steaks) in the cooking chamber. This is because the energy input into the cooking product(s) using hot air is scaled with the surface area of the cooking product, allowing the user to make an appropriate adjustment. If the target cooking chamber climate can be achieved, the adjustment can be made automatically, particularly taking a recipe selection and/or a measured (core) temperature profile of the cooking product(s) into account.

However, cooking appliances are increasingly used in professional and large kitchens which can cook the cooking products in different or combined ways. In addition to the conventional methods, such as hot air and/or steam, modern cooking appliances often also use (additional) microwave sources which (additionally) introduce energy into the cooking product(s) by means of electromagnetic radiation to (additionally) heat the cooking product(s). Both magnetrons and semiconductor components can be used as microwave sources.

If microwaves are (additionally) used in the cooking chamber, the reproducibility of the cooking result for different load quantities deteriorates. This is due to the fact that there is no linear scalability between the microwave energy and the load quantity, which is not intuitively comprehensible to the user. Finally, this phenomenon is due to the competitive behavior between the cooking products in the microwave field and the load-dependent efficiency.

For example, half a tray of steaks (3 steaks) at 2 KW of available microwave power absorbs about 600 W (so about 200 W per steak) of the microwave power. Three trays with six steaks each absorb about 1500 W (so about 80 W per steak). In other words, the three trays of steaks absorb less than half the power per steak compared to a load of only half a tray of steaks.

This example shows that with a well-functioning recipe for cooking a certain amount of cooking product using microwaves, the amount of cooking product cannot simply be varied. In particular, based on a well-functioning recipe, a reduction in the amount of cooking product can lead to overcooking of the cooking product(s). Increasing the load, on the other hand, carries the risk of undercooking.

Accordingly, there is a need to provide a simple and cost-effective way of ensuring a good and reproducible cooking result for different load quantities when cooking products are cooked using microwave energy.

### SUMMARY

Embodiments of the present disclosure provide a method for a load-dependent setting of a microwave power in a cooking appliance having a cooking chamber and a microwave module, comprising the steps of:
determining a number of dielectric unit volumes in the cooking chamber;
determining a target microwave power on the basis of the number of dielectric unit volumes; and
setting the microwave power of the microwave module on the basis of the determined target microwave power.

The basic idea is to use a dielectric unit volume which absorbs a certain microwave power, such that different loading scenarios (type, size, geometry and number of cooking products) can be compared with each other.

The number of dielectric unit volumes in the cooking chamber can then be used to determine the microwave power to be fed in for a desired cooking result. In this context, the term “number” is to be understood as also including fractions, in particular less than 1. Thus, it is also possible to have or determine half a dielectric unit volume.

If the same microwave power is fed into the cooking chamber per unit volume, for example 70 W, then the individual cooking products in the cooking chamber each absorb the same microwave power and the same cooking result is obtained (with the same thermal cooking chamber climate). In other words, a reproducible cooking result is achieved regardless of the load quantity, even if (additional) microwave energy is supplied.

The microwave power may in particular be self-regulating with respect to a load introduced into the cooking chamber. This means that the microwave power is automatically adjusted to the amount of cooking product present in the cooking chamber. The quantity is for example detected automatically. Alternatively, it can also be specified by a user. Self-regulation reduces the effort for the user and lowers the risk of incorrect microwave power settings.

In one variant of the method, a quality Q of the cooking chamber is determined in a loaded state. Based on the quality, the number of dielectric unit volumes in the cooking chamber is then determined.

The quality may be an approximate parameter which is determined from the scattering parameters S of the incoming or outgoing microwaves in the cooking chamber.

The scattering parameters, in turn, are characteristic quantities of the microwave system and quantify the transmission and reflection behavior of the microwaves in the cooking chamber.

To determine the scattering parameters S, the incoming power waves a and the outgoing power waves b can be measured at the at least one antenna of the microwave module. The equation b=S*a applies.

For a plurality of antennas, a scattering parameter matrix is obtained.

The approximate quality Q (for the sake of simplicity, only the quality is referred to below) in turn quantifies variations in the scattering parameters.

It can be determined using the following equation:

$$Q = \frac{1}{{n}_{f} * {n}_{a}^{2}} {\sum }_{f} {\sum }_{i , k} \vert \frac{d}{df} \vert {s}_{ik} ( f ) \vert \vert$$

Here, n_{f} is the number of frequencies considered (at least one), nₐ is the number of antennas (at least one), and sᵢₖ is the entries in the scattering parameter matrix (i-th row and k-th column).

By varying the frequency, different microwave modes can be excited, which each introduce more or less power into the cooking product, depending, for example, on the loading scenario, i.e. the load quantity and the location of the cooking product in the cooking chamber. This can be compared to a scanning of the cooking product.

Considering the mean value over the frequencies and scattering parameter entries can be understood as homogenization of the electric field.

The quality is thus a parameter which characterizes the absorption behavior of the loaded or unloaded cooking chamber in a simple numerical value and is therefore ideally suited for carrying out the method according to the disclosure.

Basically, it is known how the quality is determined, wherein different methods can be used therefor, as described, among others, in documents DE 10 2020 104 763 A1, DE 10 2019 127 620 A1 or DE 10 2021 131 619 A1.

Of course, the above-described way of determining the (approximate) quality is not to be understood in a restrictive manner. Other possibilities for determining the quality are also conceivable, for example by solving the Maxwell equations.

As already explained, the number of dielectric unit volumes may be deduced from the quality.

A dielectric unit volume can characterize the microwave power which can be absorbed by a defined body of a material under predetermined conditions.

For example, the dielectric unit volume can represent the same dielectric load as a cube of water having an edge length of 4 cm. Of course, this is only an example and is not to be understood in a restrictive manner. The dielectric unit volume can be freely selected in its shape and size.

According to an embodiment, the dielectric unit volume can also characterize the dielectric load of a cuboid, in particular a cube, or a sphere made of a certain material. Each cooking product can in turn be regarded as a body consisting of a defined number of unit volumes.

The use of comparatively simple geometric shapes in the definition of the dielectric unit volume is advantageous as this leads to lower (computational) effort when carrying out the method.

It is conceivable that the dielectric unit volume is a calculated parameter, in particular a parameter determined by means of a simulation or an experimentally determined parameter.

For example, the dielectric unit volume can be determined by calculating the total absorbable microwave powers in the underlying body (cuboid, sphere, etc.). This in turn results from the shape of the body itself and the dielectric properties thereof.

The dielectric unit volume may, for example, be determined by a numerical simulation of the radio-frequency properties (RF-FEM) of the cooking product based on the finite element method (FEM) and/or by calculating a volume integral over the electric field norm in the cooking product. To simplify matters, it can be assumed that the microwaves are incident plane waves.

To improve the accuracy of the method, it is also conceivable to take the absorption properties of the empty cooking chamber into account when determining the number of dielectric unit volumes. This can be realized by determining the number of dielectric unit volumes on the basis of a ratio of the quality of the cooking chamber in a loaded state to a quality of the cooking chamber in an unloaded state.

In one variant of the method, the number of dielectric unit volumes is determined on the basis of a defined, in particular experimentally determined, relationship between the quality of the cooking chamber and a dielectric volume of the cooking chamber or the cooking product.

The dielectric volume characterizes the microwave power which can be absorbed by the (loaded) cooking chamber.

The relationship between the quality of the cooking chamber and the dielectric volume of the cooking chamber may be stored in a memory of the cooking appliance in the form of a table or graph. If the scattering parameters and therefrom the quality of the loaded cooking chamber are now determined on the basis of measurements of the incoming and outgoing microwaves during (or prior to) a cooking process, then the known relationship can be used to directly derive the dielectric volume or the number of dielectric unit volumes.

The number of dielectric unit volumes in the cooking chamber can thus be determined automatically without user intervention, which simplifies the cooking process as a whole.

If the number of unit volumes is known, the target microwave power can be determined on the basis of a preset set microwave power for a single dielectric unit volume. This is technically easy to implement and not prone to error. The set power may be a value stored in the memory of the cooking appliance and/or a value specified by a user.

In one embodiment of the method, if the target microwave power is greater than a nominal power or a limit power for the microwave power of the at least one microwave module which is preset in terms of control, a determination and setting of an extended cooking time is provided. This reliably prevents undercooking in case of large load quantities.

In this context, it is also conceivable that a heating and/or steam device of the cooking appliance is operated at a reduced power during the extended cooking time. According to an embodiment, the power of the heating and/or steam device is reduced to such an extent that the cooking product is always cooked with the same ratio of introduced cooking energies of the different energy sources. In simple terms, this prevents the cooking product from absorbing too much heat (for example, from hot air) during the extended cooking time, which may lead to drying out and/or overcooking.

Furthermore disclosed is a cooking appliance comprising a cooking chamber and at least one microwave module which is configured and set up to feed electromagnetic radiation into the cooking chamber to cook a cooking product introduced into the cooking chamber by means of microwave energy. The cooking appliance has a control and/or evaluation unit which is configured and set up to execute a computer program with program code means for carrying out a method according to the disclosure. The advantages discussed in relation to the method apply accordingly to the cooking appliance.

### BRIEF DESCRIPTION OF THE DRAWINGS

Further features and advantages will become apparent from the description below and from the drawings to which reference is made and in which:

FIG. 1 shows a schematic representation of a cooking appliance according to the present disclosure, loaded with a cooking product; and

FIG. 2 shows a graphic plot of an experimentally determined curve of a dielectric volume of a cooking chamber against the quality of the cooking chamber.

### DETAILED DESCRIPTION OF THE DRAWINGS

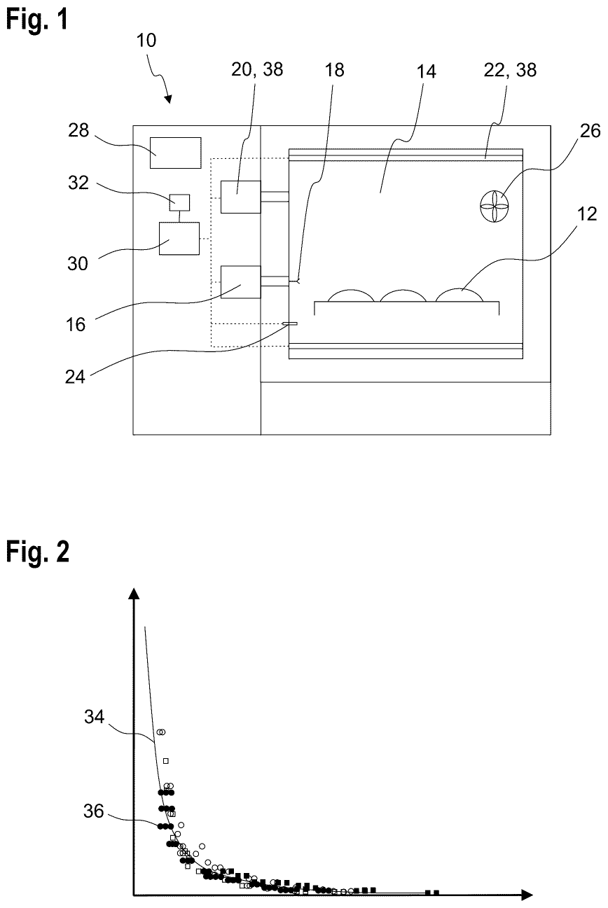

FIG. 1 shows an example embodiment of a cooking appliance 10 according to the present disclosure, which is loaded with a plurality of cooking products 12 to be cooked. To simplify matters, the following description will always refer to “the cooking product 12”, even in case of a loading with a plurality of cooking products.

The cooking appliance 10 has a cooking chamber 14 and at least one (preferably a plurality of) microwave module(s) 16. For the sake of simplicity, only one microwave module 16 is shown in FIG. 1.

The at least one microwave module 16 comprises a semiconductor microwave source (“Solid State Microwave Generator”—SSMG) and is configured and set up to feed microwave beams into the cooking chamber 14. The microwave beams can have a frequency which is suitable for heating the cooking product 12 located in the cooking chamber 14. For example, the frequency is between 2.1 GHZ and 2.8 GHZ, in particular 2.4 GHz to 2.5 GHZ. In one embodiment, the frequency is approximately 2.45 GHz.

The at least one microwave module 16 can be equipped with an antenna 18 and a directional coupler (not shown) for feeding into the cooking chamber 14. However, several antennas 18 and directional couplers can also be provided for each microwave module 16.

In addition, the at least one microwave module 16 can comprise further components or parts, for example a modulator, an amplifier, a demodulator and/or a controller (not shown).

In the example embodiment, the cooking appliance 10 is a combination appliance which has, in addition to the at least one microwave module 16, various other assemblies for cooking the cooking product 12, in particular hot air and/or steam sources 20 and infrared heating sources 22. Of course, this is not to be understood in a restrictive manner. Other types of heating devices are also conceivable.

Furthermore, the cooking appliance 10 in the example embodiment includes a temperature sensor 24, by means of which the cooking chamber temperature can be detected, as well as a fan wheel 26, which can be operated in a reversible manner to homogeneously mix the cooking chamber atmosphere. This is, of course, not to be understood in a restrictive manner. Cooking appliances 10 according to the present disclosure having no fan wheel 26 or more than one fan wheel are also conceivable.

Furthermore, the cooking appliance 10 shown in FIG. 1 has an input device 28, for example a touch display, by means of which a user can make entries, in particular to manually select a cooking program or to set and/or adjust desired cooking parameters.

In the example embodiment, the cooking appliance 10 also includes a control and/or evaluation unit 30, which is connected to the at least one microwave module 16, and a memory 32, in which a computer program with program code means is stored. When the computer program is executed by a processor unit (not shown) of the cooking appliance 10, it causes the control and/or evaluation unit 30 to carry out a method for a load-dependent setting of a microwave power. This method is described in more detail below.

At the start of the process, the cooking product 12 is introduced into the cooking chamber 14 of the cooking appliance 10 or is already located therein.

In an initial step of the method, the control and/or evaluation unit 30 causes the at least one microwave module 16 to feed microwave radiation into the cooking chamber 14 via the at least one antenna 18, i.e. to radiate microwaves. The antenna 18 is basically a coupling-in structure, i.e. a structure for coupling-in the microwaves.

Incoming and outgoing waves or microwaves via the antenna 18 are detected (by means of the associated directional coupler). The information thus obtained is transmitted to the control and/or evaluation unit 30.

In a further step of the method, the control and/or evaluation unit 30 determines an (approximate) quality Q of the loaded cooking chamber 14 on the basis of the information about the incoming and outgoing microwaves, for example on the basis of the above-mentioned equations.

In addition, the control and/or evaluation unit 30 retrieves a previously determined quality Q₀ of the empty cooking chamber 14 from the memory 32 and forms a ratio Q/Q₀.

The quality of the empty cooking chamber 14 can be an experimentally determined value which is permanently stored in the memory 32 of the cooking device 10. Alternatively, the quality of the empty cooking chamber 14 can also be determined by means of an empty measurement immediately before loading with a cooking product 12 and/or after an (automatic) cleaning. This has the advantage that any additional components introduced into the cooking chamber 14 are taken into account, but it is slightly more complicated for the user.

In alternative embodiments, it is also conceivable for a user to specify the quality of the loaded and/or unloaded cooking chamber 14 via the input device 28.

In a further step of the method, the control and/or evaluation unit 30 retrieves a previously defined dielectric unit volume V_{mw,0} from the memory 32. Alternatively, the dielectric unit volume can also be specified by a user via the input device 28.

In particular, the dielectric unit volume can also depend on a selected cooking program. If, for example, steaks are prepared in the cooking process, the dielectric unit volume can, figuratively speaking, refer to one or more steaks.

The dielectric unit volume is characterized by the microwave power which can be absorbed by a defined body (e.g. in the form of a sphere, a cuboid or a typical steak shape) made of a defined material (e.g. water, meat, etc.) under predetermined conditions (e.g. at a certain microwave frequency or in a certain frequency range and/or at a certain temperature).

In simple terms, the dielectric unit volume can thus correspond to the dielectric load of the defined body. A corresponding cooking product can then correspond to a number of such defined bodies, i.e. from a dielectric point of view or with regard to the dielectric load.

In the example embodiment, the dielectric unit volume is an experimentally determined parameter which is stored in the memory 32 of the cooking appliance 10. Alternatively, however, it can also be a calculated parameter, in particular a parameter determined by simulation.

Of course, a plurality of different dielectric unit volumes can also be stored in the memory 32, for example for different cooking products such as meat, fish, pastries, etc.

In a further step of the method, the control and/or evaluation unit 30 determines a number n of dielectric unit volumes in the loaded cooking chamber 14 (for example, of three trays of steaks).

To this end, the control and/or evaluation unit 30 in the example embodiment retrieves a known relationship (in the present case an experimentally determined relationship) between the quality Q of the cooking chamber 14 and a dielectric volume V_{mw} of the cooking chamber 14 from the memory 32.

FIG. 2 schematically shows this relationship determined experimentally from several measurements by means of a graph 34.

Specifically, FIG. 2 shows the experimentally determined relationship between the dielectric volume normalized to the unit volume V_{mw}/V_{mw,0} and the quality Q/Q₀ normalized to the empty cooking chamber 14. The measuring points 36 of the various measurements are also shown.

If the quality Q of the loaded cooking chamber 14 (determined in the method by measuring the incoming and outgoing microwaves or power waves) of the loaded cooking chamber 14 and thus the ratio Q/Q₀ is determined, then, on the basis of the relationship shown in FIG. 2, the number n of dielectric unit volumes can be directly derived, as it corresponds directly to the dielectric volume V_{mw}/V_{mw,0} normalized to the unit volume.

In other words, dielectric load detection is possible, i.e. to detect the dielectric load in the cooking chamber 14, as the number n of dielectric unit volumes can be determined.

Of course, the manner of determining the number of unit volumes as described above is not to be understood in a restrictive manner. Alternatively, the number can also be determined by specifying or measuring the weight and/or the volume of the cooking product 12 and correlating this or these value(s) with the dielectric unit volume.

In a further step of the method, the control and/or evaluation unit 30 determines a target microwave power P_{target} of the at least one microwave module 16 on the basis of the determined number of dielectric unit volumes.

To this end, the control and/or evaluation unit 30 first retrieves from the memory 32 a set power Pₛₑₜ to be absorbed per unit dielectric volume, at which a good cooking result is to be expected. Alternatively, the set power can also be specified by a user via the input device 28 and/or be preset by a recipe. In particular, the set power can be an experimentally determined value or an empirical value of the user.

Subsequently, the control and/or evaluation unit 30 determines a power P_{food} to be absorbed in total by the cooking product 12, for example on the basis of the equation P_{food}=n Pₛₑₜ, on the basis of the previously determined number n of unit volumes and the set power Pₛₑₜ.

The target microwave power P_{target} can then be determined from the total power P_{food} to be absorbed by the cooking product 12 and the quality Q/Q₀ normalized to the empty cooking chamber 14, for example using the equation P_{target}=P_{food}/(1−Q/Q_{empty}).

In the event that the target microwave power P_{target} is less than or equal to a nominal power P_{N} of the at least one microwave module 16 (for example 2 KW), the control and/or evaluation unit 30 sets the microwave power of the at least one microwave module 16 on the basis of the target microwave power in a further step of the method.

However, if the target microwave power is greater than the nominal power of the at least one microwave module 16, the control and/or evaluation unit 30 determines an extended cooking time t_{new}. It is thus ensured that the cooking product 12 is not undercooked due to the limited power of the at least one microwave module 16 and a cooking time which is too short.

In particular, it may be provided that the at least one microwave module 16 is operated at the nominal power during the extended cooking time.

In the example embodiment, the control and/or evaluation unit 30 calculates the extended cooking time t_{new} on the basis of the cooking time t_{target} originally envisaged for the cooking process or by the selected recipe and on the basis of the target microwave power P_{target}. To this end, identical amounts of energy to be introduced are assumed for the originally planned and the extended cooking process, and the equation P_{target}*t_{target}=P_{N}*t_{new} is applied.

Taking the relationships between the individual parameters explained above into account, the following equation is obtained: t_{new}=t_{target}*n*Pₛₑₜ/P_{N} (1−Q/Q_{empty}).

In the example embodiment, during the extended cooking time, the hot air and/or steam sources 20 and the infrared heating sources 22 (collectively also referred to as heating and/or steam devices 38) are operated at reduced power. This ensures that the cooking product 12 does not dry out or is overcooked during cooking with the extended cooking time.

All aforementioned steps of the method can be carried out automatically, for example by the control and/or evaluation unit 30 of the cooking appliance 10. The microwave power is thus self-regulating with respect to the load introduced into the cooking chamber 14. This considerably reduces the risk of incorrect settings. In addition, the user is not faced with the problem of performing a microwave power setting which is not intuitive for him.

Therefore, reproducible cooking results are achieved without additional user inputs. In particular, this also makes it possible to achieve precise target temperature cooking with different loading scenarios (for example, heating 100 ml of milk or 1 liter of milk to a predetermined temperature) without having to specify the load quantity separately.

Of course, alternative example embodiments are also conceivable in which one or more specifications are made by a user.

1. A method for a load-dependent setting of a microwave power in a cooking appliance having a cooking chamber and a microwave module, comprising the steps of:
determining a number of dielectric unit volumes in the cooking chamber;
determining a target microwave power on the basis of the number of dielectric unit volumes; and
setting the microwave power of the microwave module on the basis of the determined target microwave power.

2. The method according to claim 1, wherein the microwave power is self-regulating with respect to a load introduced into the cooking chamber.

3. The method according to claim 1, wherein a quality of the cooking chamber in a loaded state is determined, and wherein the number of dielectric unit volumes in the cooking chamber is determined based on the quality.

4. The method according to claim 1, wherein the dielectric unit volume is characterized by a microwave power which can be absorbed by a defined body of a material under predetermined conditions.

5. The method according to claim 1, wherein the dielectric unit volume is a calculated parameter.

6. The method according to claim 1, wherein the dielectric unit volume is determined by a simulation.

7. The method according to claim 1, wherein the dielectric unit volume is an experimentally determined parameter.

8. The method according to claim 1, wherein the number of dielectric unit volumes is determined on the basis of a defined relationship between the quality of the cooking chamber and a dielectric volume of the cooking product.

9. The method according to claim 8, wherein the defined relationship between the quality of the cooking chamber and the dielectric volume of the cooking product is experimentally determined.

10. The method according to claim 1, wherein the target microwave power is determined on the basis of a set microwave power preset for a single dielectric unit volume.

11. The method according to claim 1, wherein, after determination that the target microwave power is greater than a nominal power of the microwave module, an extended cooking time is determined and set.

12. The method according to claim 11, wherein at least one of a heating device or steam device of the cooking appliance is operated at a reduced power during the extended cooking time.

13. A cooking appliance having a cooking chamber, at least one microwave module configured and set up to feed electromagnetic radiation into the cooking chamber to cook a cooking product introduced into the cooking chamber by microwave energy, and a control and/or evaluation unit which is configured and set up to execute a computer program with program code for carrying out the method according to claim 1.
